(19) United States
(12) Patent Application Publication
(10) Pub. No.: US 2004/0265103 A1
(43) Pub. Date: Dec. 30, 2004

(54) Latch for a tire carrier

(76) Inventors: Casimir R. Kiczek, Livonia, MI (US); Dorin Morgos, West Bloomfield, MI (US); Jamie Zinser, Royal Oak, MI (US)

Correspondence Address: Intellectual Property Department, Dura Automotive Systems, Inc., 2791 Research Dr., Rochester Hills, MI, 48309, US

(21) Appl. No.: 10/608,167

(22) Filed: Jun. 26, 2003

(51) Int. Cl. B62D 43/00

(52) U.S. Cl. 414/463

(57) ABSTRACT

A latch assembly for use in a vehicle with a tire and rim with an aperture is disclosed. The latch assembly includes a tire carrier, a flexible member with one end attached to a vehicle or a tire carrier. Additionally, a locking member is connected to the flexible member and disposed in the aperture to detachably connect the flexible membr to the rim. The locking member is a clamp member or a hook member.

### CROSS REFERENCE TO RELATED APPLICATIONS

Not Applicable.

### STATEMENT REGARDING FEDERALLY SPONSORED RESEARCH

Not Applicable

### REFERENCE TO MICROFISHE APPENDIX

Not Applicable

### FIELD OF THE INVENTION

The present invention generally relates to a tire carrier for a vehicle and, more particularly, to a latch for maintaining the tire carrier in a stowed position.

### BACKGROUND AND SUMMARY OF THE INVENTION

Vehicles with tires such as passenger cars, light and heavy duty trucks, tractor trailers, buses, commercial delivery vehicles, among other motorized forms of transportation and trailers pulled by such vehicles are conventionally equipped with spare tires. Some spare tires are stored under the vehicle using a tire carrier which includes a tire winch for raising and lowering the spare tire between a raised or stored position and a lowered or accessed position. The winch typically raises and lowers the spare tire using a flexible member such as a cable or cord, which is wound and unwound on a spool or reel. A second latch is sometimes provided to secure the spare tire in the stored position. If the flexible member of the tire carrier or winch fails while the spare tire is in the stored position, the second or secondary latch ensures that the spare tire remains in the stored position.

For example, U.S. Pat. No. 5,188,341, the disclosure of which is expressly incorporated herein in its entirety, discloses a secondary latch for a tire carrier. The secondary latch includes a latch member, which is pivotally mounted to swing a pair of arcuate fingers between a locked position and an unlocked position. The lock member is biased to the locked position by gravity. The lock member is selectively pivoted to the unlocked position by a lever, which is activated by a cranking member when engaging the winch.

In U.S. Pat. No. 6,079,932 a safety latch assembly is disclosed, which includes a pair of pivoted and spring loaded opposed latched to engage the shoulder portion of a support member. One latch has a cam portion or toothed portion to cause pivotable movement of the other latch. An actuator is required to pivotally move one latch on a pivot pin against the force of a spring to unlatch the shoulder. The pivotal movement of the one latch caused by the actuator moves the bottom end of the one latch outwardly and away from the shoulder and moves the top end of the one latch inwardly in a latch housing. This movement of the one latch pushes the cam surfaces together to pivotally move the other latch against the force of its associated spring to unlatch the shoulder and release the safety latch.

Another example is shown in U.S. Pat. No. 6,267,546 issued to Dura Global Technologies, Inc, the disclosure of which is expressly incorporated herein in its entirety. The secondary latch assembly includes a sliding latch member supported by a horizontal support surface and an actuator adapted to selectively move the latch member along a linear path between a locking position and an unlocking position. The latch member is adapted to permit passage of the shank portion but not the head portion past the latch member when the latch member is in the locking position and to permit passage of both the shank portion and the head portion past the latch member when the latch member is in the unlocking position. The actuator includes an arm pivotable between the locking position and the unlocking position and having one end extending through an opening formed in the latch member such that pivotal movement of the arm linearly moves the latch member. The actuator further includes a spring member biasing the arm to the locking position. Various alternative embodiments are also disclosed wherein the actuator arm is connected to the latch member with a pin-and-slot connection and wherein the latch member has resilient fingers.

While these secondary latches may effectively retain the spare tire in the stored position under some conditions, they have numerous shortcomings. For example, many of these mechanisms are fairly complex and require a relatively large number of parts and some are subject to corrosion from road salt. Accordingly, there is a need in the art for a secondary latch, which has reduced a number of total parts, is less prone to salt corrosion, and has reduced assembly complexity. These prior art devices do not teach the applicant's invention.

A simpler design is shown by Sauner in U.S. Pat. No. 5,975,498. Sauner discloses a spare tire and wheel assembly, which uses a primary flexible cable releasably, attached to the wheel-retaining bracket that supports the spare tire and wheel assembly. A winch assembly is used to raise and lower the spare tire and wheel assembly between a lower or accessing position resting on the ground and a stored or upper position. A secondary cable is secured at one end by a crimp connector to the primary cable above the bracket and extends through an offset hole within the bracket to receive a stop fitting below the bracket. In the event that the primary cable breaks adjacent to the retaining bracket, the secondary cable prevents the tire and wheel assembly from disengaging the vehicle. The device has not met with wide acceptance since the secondary cable does not prevent the wheel assembly from disengaging the vehicle in event that the winch fails or the primary cable breaks above the crimp connection to the secondary cable. This device does not teach the invention as taught by the applicant's invention.

The present invention provides a latch mechanism for a vehicle, which overcomes some of the above-noted problems of the related art. According to the present invention, a latch assembly is adapted for use with a vehicle including a tire, the tire has a rim with at least one aperture. The latch assembly includes, in combination a tire carrier. A first flexible member has one end attached to one of the vehicle and the tire carrier and another end. Additionally, a locking member is attached to another end of the flexible member. The locking member is disposed in the aperture to detachably connect the flexible member to the rim. The locking member is one of a clamp member and a hook member.

The advantage of the present invention is that the latch assembly is simple, more reliable and requires fewer parts. From the foregoing disclosure and the following more detailed description of the preferred embodiment, it will be apparent to those skilled in the art that the present invention provides a significant advance in the technology and art of latching mechanisms. Particularly significant in this regard is the potential the invention affords for providing a lightweight, high quality, feature-rich, low cost assembly. Additional features and advantages of the preferred embodiment will be better understood in view of the detailed description provided below.

### BRIEF DESCRIPTION OF THE DRAWINGS

These and further features of the present invention will be apparent with reference to the following description and drawings, wherein:

FIG. 1 is a planar view of a vehicle with the latch assembly according to the present invention;

FIG. 1A is an enlarged view of one embodiment of the locking member in FIG. 1;

FIG. 2 is a planar view of the locking member of FIG. 1 in an unlocked condition;

FIG. 3 is a planar view of the locking member of FIG. 1 in a locking condition;

FIG. 4 is a planar view of the locking member connected to the locking flexible member according to one embodiment of the invention;

FIG. 5 is a planar view of the locking member connected to the rim;

FIG. 6 is a planar view of the locking member and tire carrier connected to the rim;

FIG. 7 is a planar view of the locking member according to a second embodiment of the invention;

FIG. 8 is a planar view of the locking member according to a third embodiment of the invention;

FIG. 9 is a planar view of the locking member according to the fourth embodiment of the invention; and

FIG. 10 is a planar view of the locking member according to the fifth embodiment of the invention.

It should be understood that the appended drawings are not necessarily to scale, presenting a somewhat simplified representation of various preferred features illustrative of the basic principles of the invention. The specific design features of a latch assembly as disclosed herein, including, for example, specific shapes of the locking member will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the latch assembly illustrated in the drawings. In general, up or upward refers to an upward direction in the plane of the paper and down or downward refers to a downward direction in the plane of the paper.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved latch assembly for a tire carrier disclosed herein. The following detailed discussion of various alternative and preferred embodiment will illustrate the general principles of the invention with reference to a latch assembly for use with a vehicle. Other embodiments suitable for other applications will be apparent to those skilled in the art given the benefit of this disclosure.

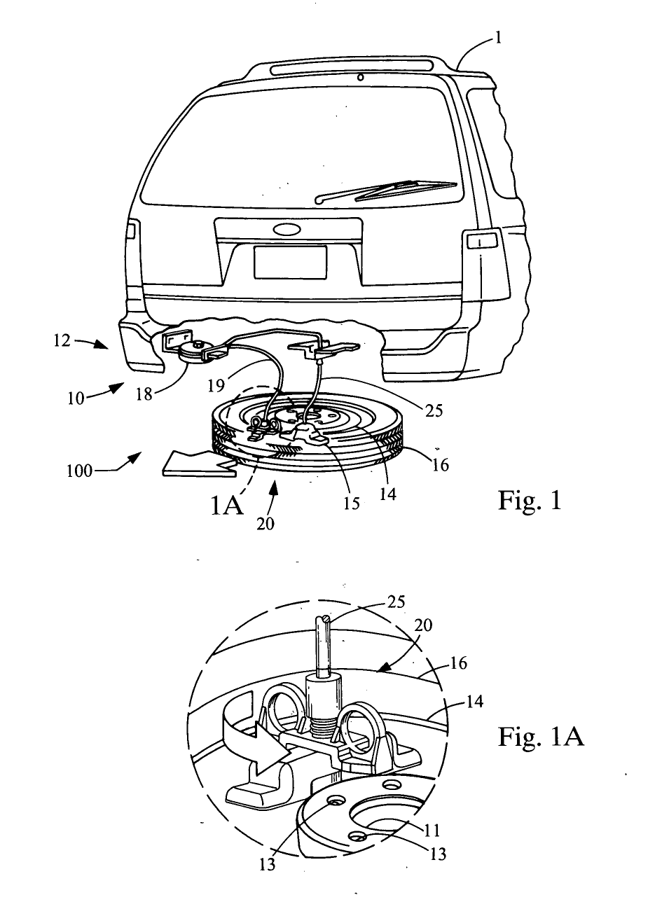

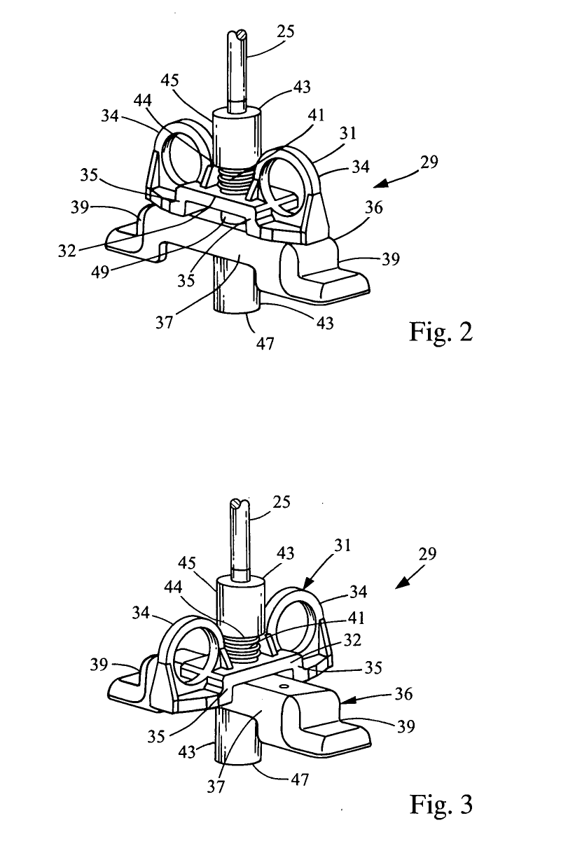

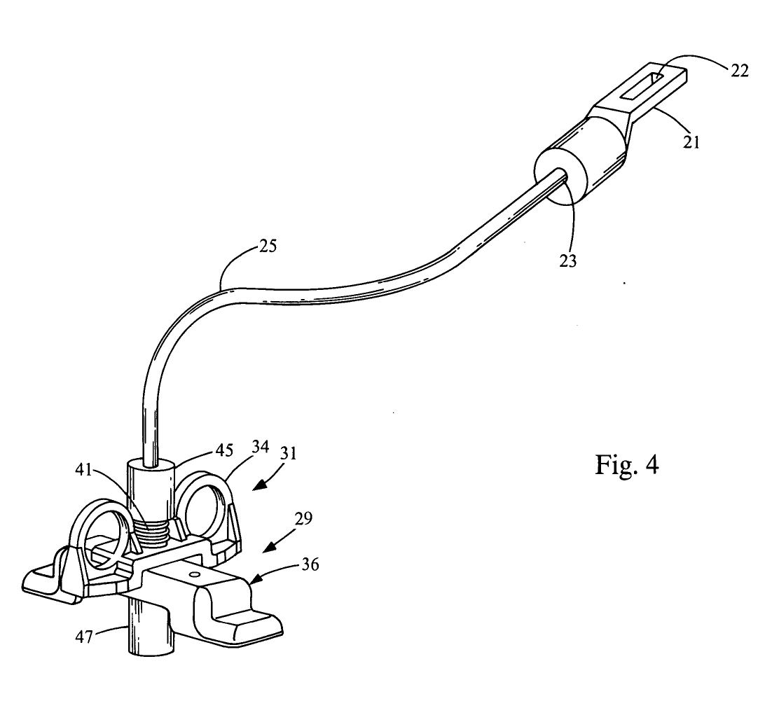

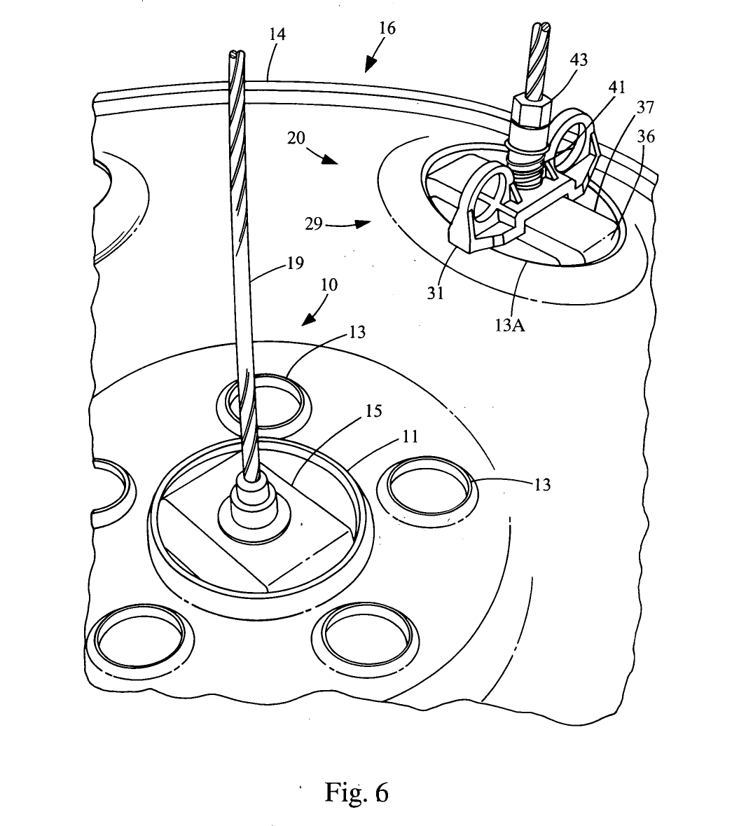

Referring now to the drawings, FIGS. 1-6 illustrate one embodiment of a latch assembly 100 for a spare tire of a vehicle utilizing a tire carrier assembly 10 and a locking assembly 20 according to the present invention. While the illustrated embodiments of the present invention are particularly adapted for use with a motor vehicle, it is noted that the present invention can be utilized with any vehicle having tires such as automobiles, trucks, vans, SUV's, recreational vehicles, off road vehicles for example, dune buggies, golf carts, and the like and non-motorized vehicles such as carts, wagons, trailers and the like.

Tire carrier assembly 10 includes tire carrier 12 for carrying and supporting a spare tire 16 thereon, a winch assembly 18, a tire-carrier plate 15 and a winch flexible member 19. The spare tire 16 has a rim 14 with a central hole 11, at least two apertures 13, and underside 17 and at least one a lightner aperture 13A. The winch 18 is mounted on a shaft, which is connected to the vehicle for raising and lowering tire carrier 12 between an upper or storing position and a lower or accessing position. The winch flexible member 19 has one end connected to the winch assembly and the other end that is detachably attached to the spare tire. The tire carrier plate 15 is a longitudinal member that is inserted through the central hole 11 to engage the underside 17 of the rim in order to raise and lower the spare ire 16. The winch flexible member can take several forms including a rope, cable, wire and the like.

Locking assembly 20 is provided for securing the spare tire 16 to the vehicle in the event that the winch flexible member 19 fails, breaks or becomes detached from the spare tire or the winch fails to keep the tire in a stored position. Locking member 20 includes a locking flexible member 25 with one end 23 and another end 27. The one end 23 is connected to the vehicle with a conventional fastener or alternately, a clip or eyelet member 21 is fastened to the one end 23. Optionally, clip 21 is fastened to the tire carrier or the winch by a conventional fastener. The clip member 21 has an aperture 22 and a portion to which the one end of flexible member 25 is conventionally connected thereto, such as by crimping. The another end 27 of the flexible member 25 is connected to latch member 29.

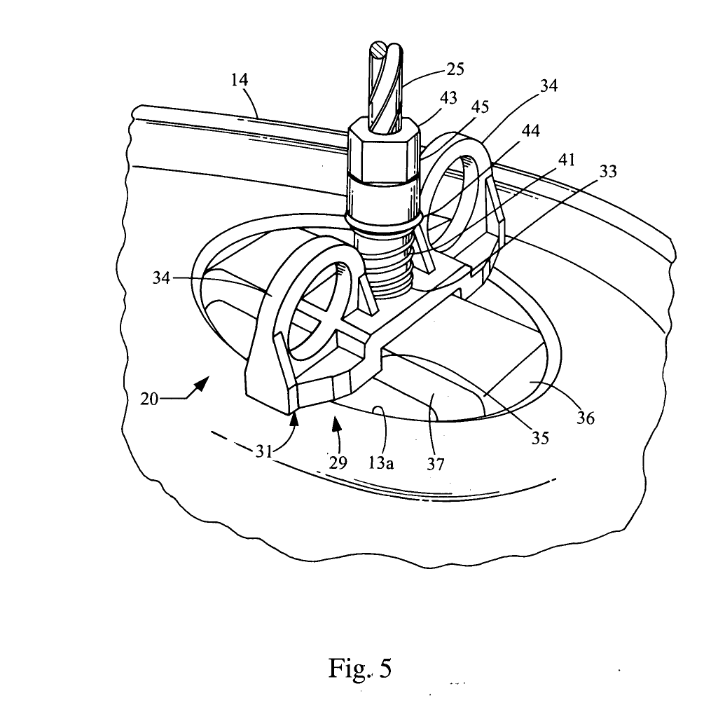

The illustrated latch member 29 includes a support plate 31, a latching member 36, a biasing member 41 and a pair of stops 43. The support plate has a longitudinal portion 32 with an aperture 33, a pair of offset sections 35 and a pair of finger engaging portions 34 near each end of the support plate. The latching member 36 includes a longitudinal section 37, a pair of offset portions 39 near each end of the longitudinal section to engage underside 17 of rim 14 when the latching member 36 is inserted into lightner aperture 13A of rim 14. The offset portions 39 are formed to fit within the lightener aperture. The longitudinal section 37 has an aperture 38. One of the pair of stops 43 includes one end portion 45 formed with an outer diameter, an internal passage and a shoulder portion 44. The other pair of stops 43 includes another end portion 47 with an inner hole, an outer diameter, a shoulder portion 48 and a necked down portion 49. Flexible member 25 passes through the inner passage and the inner hole. One end portion 45 is crimped conventionally onto flexible member 25 spaced away from another end 27 and the other end portion 47 is crimped onto the flexible member 25 near the another end 27. Another end 47 is adjacent to the one end portion 45 after the flexible member 25 is inserted into aperture 33 of the support plate and aperture 38 of latching member 36. Support plate 31 is disposed around the outer diameter of one end portion 45 and latching member 36 is disposed around necked down portion 49. Necked down portion 49 is formed to pass through the aperture 38, aperture 33 and to abut against end portion 45. Biasing member 41 is disposed about the outer diameter of one end portion 45 adjacent shoulder portion 44 and adjacent longitudinal portion of support plate 31 to urge support plate 31 toward latching member 36. The illustrated biasing member is a coil spring but optionally, member 41 includes a first and a second coil spring to provide a tailored biasing force on the support plate. Alternatively, the biasing member is a leaf spring, an elastomeric member such for example, micro-cellular polyurethane that has a spring rate that is designed to meet the application retention requirements or foamed silicone, and a spring and an elastomeric member. As illustrated in FIG. 5, the rim 14 has a lightener aperture 13A that is radially offset from the central hole in the rim and is oval shaped with a major diameter 13B and a minor diameter 13C. Optionally, the lightener aperture is an arcuate shape, a multi-sided shape and an elliptical shape. The longitudinal portion 32 of support plate 31 has a length that is sized to fit into the major diameter or the largest dimension of aperture 13A. The support plate 31 is rotated when the operator's fingers engage the finger portions 34 to sandwich the rim between the support plate and the latching member. One hand operation rotation of support plate 31 is facilitated when the latching member is captured in the lightener aperture. The diameter of both flexible members is the same depending on the material properties of the respective flexible members and further optionally, the diameter of the winch flexible member is less than the diameter of the locking flexible member to support the spare when the winch flexible member fails or the winch fails to hold the spare tire in the stored position.

In operation, the tire carrier is attached to the tire so that the first or winch flexible member detachably connects the tire to the winch and the tire carrier plate supports the tire as the tire and rim are moved from a stored position to an accessible position and from the accessible position to a stored position. When the operator desires to move the tire from the accessible position to the stored position, the operator attaches the locking member to the tire. The locking or second flexible member is connected to the vehicle and detachably connected to the tire. With the locking member in the unlocked position, the support plate forms a gap between the support plate and the latching member. The locking member is inserted into the lightener hole so that the support plate is seated within the hole and the bearing surface of the finger engaging portion is adjacent to the latching member but the bearing surface is axially located above the plane of the rim adjacent the lightener hole. Then, the operator rotates the support plate relative to the latching member so that the offset sections 35 of the support plate no longer contact the latching member and the biasing member urges the support member toward the latching member to clamp or sandwich the rim between the support plate and the latching member. The offset sections 35 are sized relative to latching member so that upon rotation of the support member from the unlocked condition to the locked condition, the force of the biasing member causes the rim to be clamped between the support member and the latching member and to produce an audible indication that the clamping function is operational and to resist the support plate from separating from the latching member. With the locking member attached to the tire, the operator causes the tire carrier to raise the tire to a stored position. In the event that the winch cable fails or breaks or the winch fails to hold the spare tire in the stored condition, the locking flexible member which is connected to the tire rim and the vehicle or tire carrier to prevent the tire from detaching from the vehicle.

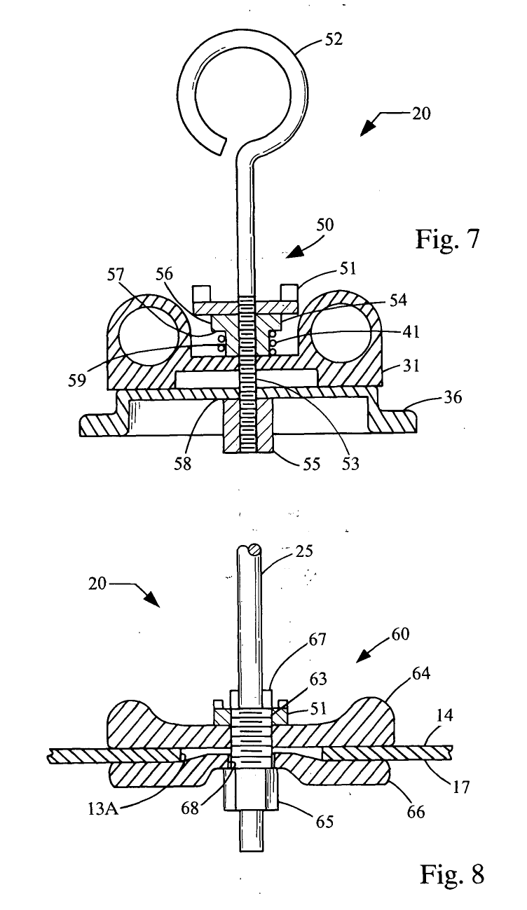

A second embodiment of the present invention is illustrated in FIG. 7. Where the elements are the same as described in first embodiment, the numerals remain the same. In this embodiment, the locking member 20 includes an eyebolt assembly 50 fastened to the locking flexible member 25. The eyebolt assembly has a hoop portion 52 that is attached conventionally to the another end of the second flexible member, an elongated section extending from the hoop portion 52 with an external thread 53, top threaded nut 54 and an end threaded nut 55 threadably engaging the threaded portion of the eyebolt. The eyebolt assembly 50 also includes biasing member 41, support plate 31 and latching member 36 as described earlier. Top nut 54 has one end portion 56 formed with an outer diameter, an internal threaded passage and a shoulder portion 57. The end-threaded nut 55 includes an end portion with an internal threaded passage, an outer diameter and a shoulder portion 58. Top nut 54 has a necked down portion 59 and threadably engages threaded portion 53. End nut 55 also threadably engages threaded portion 53 and is positioned on the eyebolt so as to be spaced away from top nut 54. Flexible member 25 is attached conventionally to the eyebolt such as by looping over the flexible member through hoop 52 and crimping a conventional fitting to connect the flexible member so as to form a loop. The elongated section is inserted into aperture 33 of the support plate and aperture 38 of latching member 36. Biasing member 41 is disposed about the outer diameter of the top nut 54 adjacent shoulder portion 57 and adjacent one side of the longitudinal portion of support plate 31 to urge support plate 31 toward latching member 36. The end-threaded nut 55 abuts against one side of the latching member 36. In all other aspects, this second embodiment operates as in the first embodiment. Optionally, a locknut 51 has a threaded internal passage that engages the threaded portion adjacent to the top nut. Lock nut 51 also has a finger-engaging portion. Nut 51 is threadably advanced toward the top to prevent the top nut from increasing the gap set between the support plate and the latching member when the support plate is rotated to snap into place relative to the latching member to clamp the rim therebetween.

FIG. 8 illustrates the third embodiment of the present invention. Where the elements are the same as in first embodiment, the numerals remain the same. In this embodiment, the locking member 20 includes a wing-nut assembly 60 fastened conventionally to the another end of the locking flexible member 25. The wing-nut assembly 60 has a top threaded wing nut 64 with finger engaging portions, an internal threaded passage, a top nut 67 with an internal passage and an external threaded portion, an end crimp nut 65 and a latching member 66. The top nut 67 is crimped to the flexible member 25 and the wing nut 64 threadably engages the threaded portion of the top nut. The latching member is formed with a longitudinal section. The longitudinal section has an internal passage 68 and two end section extending offset from the longitudinal section to engage underside 17 of rim 14 when the latching member 66 is inserted into lightner aperture 13A of rim 14. The offset portions are formed to fit within the lightener aperture. Flexible member 25 is inserted through the internal passage of the latching member 66. The end crimp nut is crimped to the flexible member 25 once the top nut, wing nut and latching member are assembled to the flexible member. Optionally, lock nut 51 with an internal threaded passage engages the threaded portion of the top nut to prevent the wing nut from increasing the gap set between the support plate and the latching member when the support plate is rotated into place relative to the latching member to clamp the rim therebetween.

The operator inserts the wing nut assembly 60 into the lightner aperture and with the latching member adjacent the rim, the operator turns the wing nut so that the wing nut moves toward the latching member (because of the threaded connection) to engage the rim. In all other aspects, this third embodiment operates as in the first embodiment.

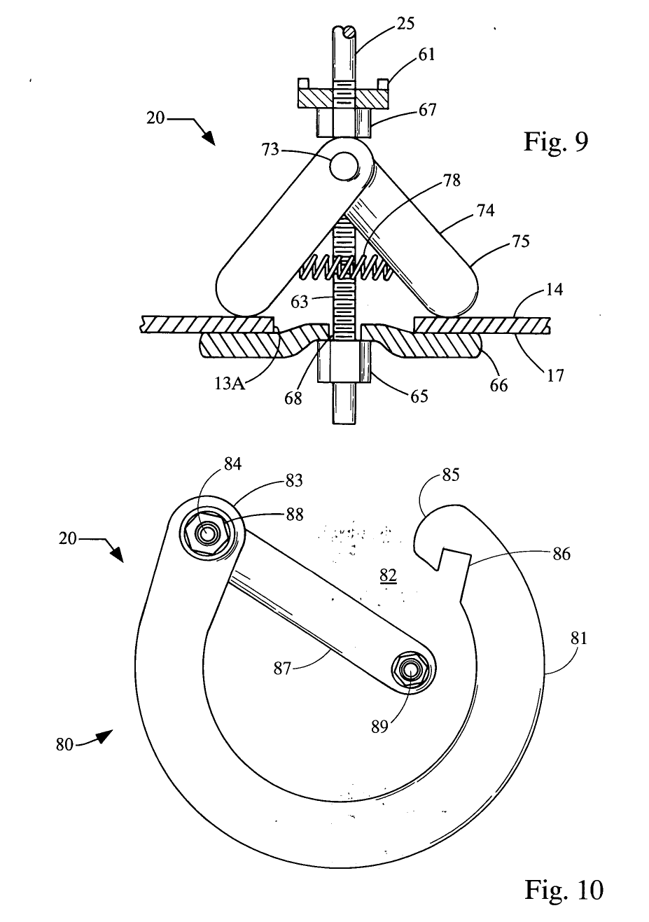

The fourth embodiment is illustrated In FIG. 9. Where the elements are the same as in first embodiment, the numerals remain the same. In this embodiment, the locking member 20 is similar to the third embodiment except that in this embodiment assembly 70 has a toggle nut 74 instead of a wing nut 64. Thus, assembly 70 includes a top threaded toggle nut 74 with a pair of finger engaging arms 75, a pivot pin 73, an internal threaded passage and a spring member 78, a top nut 67 with an internal passage and an external threaded portion, an end crimp nut 65 and a latching member 66. The top nut 67 is crimped to the flexible member 25 and the toggle nut 74 threadably engages the threaded portion of the top nut 67. Toggle nut 74 has a pair of arms, which are attached to, and rotate about pivot pin 73. Pivot pin 73 is conventionally fastened to nut 76. The top nut 67 is crimped to the flexible member 25 and the toggle nut 74 threadably engages the threaded portion of the top nut. The latching member is formed with a longitudinal section. The longitudinal section has an internal passage 68 and two end section extending offset from the longitudinal section to engage underside 17 of rim 14 when the latching member 66 is inserted into lightner aperture 13A of rim 14. The offset portions are formed to fit within the lightener aperture. Flexible member 25 is inserted through the internal passage of the latching member 66. The end crimp nut is crimped to the flexible member 25 once the top nut, toggle nut and latching member are assembled to the flexible member. Optionally, lock nut 51 with an internal threaded passage engages the threaded portion of the top nut to prevent the wing nut from increasing the gap set between the support plate and the latching member when the support plate is rotated into place relative to the latching member to clamp the rim therebetween.

The operator inserts the toggle nut assembly 70 into the lightner aperture and with the latching member adjacent the rim, the operator turns the toggle nut so that the toggle nut arms move toward the latching member (because of the threaded connection) to engage the rim. Spring 78 biases the arm toward each other and as the toggle nut is advanced toward the latching member, the spring causes the arms to form a clamping force to sandwich the rim between the toggle nut and latching member. In all other aspects, this fourth embodiment operates as in the first embodiment.

FIG. 10 illustrates the fifth embodiment of the invention. Where the elements are the same as in first embodiment, the numerals remain the same. In this embodiment, the locking member 20 is a hook member 80. Hook member is connected to the flexible member 25 by conventional means. Flexible member is formed with a loop that is inserted into hook member. Hook member has a D-shaped portion 81 with an opening 82 between two open ends of the D-shaped portion. One end 83 of the opening has a pivot pin 84 and the other end 85 has a catch aperture 86. A catch member 87 is pivotally connected by pivot pin 84 to one end 83. Catch member 87 has a biasing member 88 adjacent one end 83 and a pin 89 at the free end. Biasing member 88 urges the pin 89 into engagement with the aperture 86 to close off the opening 82. Biasing member 88 is a torsion spring disposed about the pivot pin 84. Optionally, biasing member can be a leaf spring with a finger portion urging pin 89 on the free end of catch member 87 into engage aperture 86.

In operation, with the hook member attached to the flexible member and catch member in an open condition and pivoted about one end 83 so that pin 89 is aligned with a portion of the D-shaped leg, the one end of hook member is inserted into at least two apertures 13. Apertures 13 extend radially from the central hole 11. Once inserted into the apertures, the one end and other end extend through the apertures 13 and the catch members is urged by the biasing member to close-off opening 82 and connect the rim to the flexible member. In all other aspects, this fifth embodiment operates as in the first embodiment.

What is claimed is:

1. A latch assembly adapted for use with a vehicle including a tire, the tire having a rim with at least one aperture, the latch assembly comprising, in combination:
a tire carrier having a first flexible member and a winch, the first flexible member having one end attached to the winch and another end detachably attached to the tire;
a second flexible member having one end and an other end, the one end connected to the vehicle and the other end connected to the tire; and
a locking member attached to the second flexible member, the locking member being disposed in the aperture to detachably connect to the rim, the locking member is one of a clamp member and a hook member, the locking member and the second flexible member preventing the tire from detaching from the vehicle when one of the first flexible member and the winch fails.

2. The latch assembly according to claim 1 wherein the clamp member including a latch member having a support plate and a latching member, the support plate having a longitudinal portion, the latching member having a longitudinal section, the rim being clamped between the longitudinal portion of the support plate and the longitudinal section of the latching member.

3. The latch assembly according to claim 1 wherein the clamp member including a latch member having a support plate and a latching member, the support plate being rotatably connected to the latching member.

4. The latch assembly according to claim 1 wherein the clamp member including an eyebolt having a portion attached to the second flexible member, a longitudinal portion disposed in the at least one aperture and a fastener threadably engaged to the longitudinal portion, the fastener and the longitudinal portion being disposed in the aperture, the fastener connecting the rim to the second flexible member.

5. The latch assembly according to claim 1 wherein the clamp member including a wing nut member having a portion connected to the second flexible member, a longitudinal portion with a threaded section disposed in the at least one aperture, a wing nut threadably engaging the threaded section and a latching plate adjacent the longitudinal portion, the wing nut and latching plate being secured to the rim.

6. The latch assembly according to claim 1 wherein the hook member including a arcuate portion and lock portion pivotally attached to the arcuate portion, the rim having two apertures, the hook member being disposed in at least one of the two apertures.

7. The latch assembly according to claim 1 wherein the clamp member including a toggle member having a longitudinal portion, a threaded portion, a base plate and threaded fastener, the longitudinal portion having a pair of extending wings, the base plate having a portion forming an plate aperture, the threaded portion being inserted into the plate aperture to sandwich the rim between the base plate and the pair of wings.

8. The latch assembly according to claim 1 wherein the first flexible member having a first load carrying capability, the second flexible member having a second load carrying capability, the second load capability being greater than the first load carrying capability.

9. The latch assembly according to claim 1 wherein the first flexible member having a first diameter, the second flexible member having a second diameter, the second diameter being one of bigger than the first diameter, the same as the first diameter and smaller than the first diameter.

10. The latch assembly according to claim 1 wherein the clamp member including a latch assembly having a rim support plate and a latch member connected to the plate, the rim having a web portion, the clamp member being disposed in the at least one aperture to clamp the web portion between the rim support plate and the latch member.

11. A latch assembly adapted for use with a vehicle including a tire having a rim with at least one aperture, the latch assembly comprising, in combination:
a tire carrier;
a flexible member having one end attached to one of the vehicle and the tire carrier and another end; and
a locking member attached to the another end of the flexible member, the locking member being disposed in the aperture to detachably connect the flexible member to the rim, the locking member is one of a clamp member and a hook member.

12. The latch assembly according to claim 11 wherein the rim having a portion forming at least a second aperture, the aperture having one of an elliptical shape, an arcuate shape and a multi-sided shape.

13. The latch assembly according to claim 11 wherein the clamp member is one of a latch member, an eye bolt member, a wing nut member and a toggle bolt member.

14. The latch assembly according to claim 11 wherein the clamp member including a latch member having a support plate a latching member, the clamp member being disposed in at least one aperture to detachably attach the tire to the flexible member.

15. The latch assembly according to claim 11 wherein the tire carrier having a winch, a winch flexible member and a tire plate.

16. The latch assembly according to claim 11 wherein the rim having a non-central aperture and the locking member being disposed in the non-central aperture.

17. The latch assembly according to claim 11 wherein the clamp member clamping the rim to secure the tire to the vehicle.

18. The latch assembly according to claim 11 wherein the hook member being disposed in at least one aperture to detachably secure the tire to the vehicle.

19. The latch assembly according to claim 11 wherein the clamp member including a latch member having a support plate and a latching member, the support plate having a least one off-set section, the support plate and the latch member producing an audible signal when the web portion of the rim is clamped between the support plate and the latch member.

20. The latch assembly according to claim 11 wherein the rim having a non-central aperture, the hook member being detachably engaged to the rim through the non-central aperture.
